(19) United States
(12) Patent Application Publication
(10) Pub. No.: US 2025/0360765 A1
(43) Pub. Date: Nov. 27, 2025

(54) RIGID CONNECTOR FOR MECHANICAL COUPLING OF COMPONENTS

(71) Applicant: HIRSCHVOGEL HOLDING GMBH, Denklingen (DE)

(72) Inventors: Claudia FRICK, Landsberg (DE); Marius BÜRGLE, Landsberg (DE); Simon GUGGENMOS, Fuchstal (DE)

(73) Assignee: HIRSCHVOGEL HOLDING GMBH, Denklingen (DE)

(21) Appl. No.: 19/094,005

(22) Filed: Mar. 28, 2025

(30) Foreign Application Priority Data
May 24, 2024 (DE) 102024114742.3

(51) Int. Cl. B60G 7/00; F16C 7/02

(52) U.S. Cl. CPC B60G 7/001; F16C 7/02; B60G 2206/16

(57) ABSTRACT

A rigid connecting portion for mechanical coupling of at least a first and second components includes at least one opening; a longitudinal center axis with a center point assigned to the opening; at least one end region in which the opening is arranged; an outer boundary surface at least partially surrounding the opening; and an inner boundary surface configured such that the opening is entirely bounded in a radial direction by the inner boundary surface, the inner and outer boundary surfaces arranged at a distance from each other such that the connecting portion partially surrounds the opening in a ring-like manner with a varying ring thickness.

### CROSS-REFERENCE TO RELATED APPLICATIONS

This application claims priority to German patent application No. 10 2024 114 742.3, filed May 24, 2024, the disclosure of which is hereby incorporated in its entirety by reference herein.

### TECHNICAL FIELD

The disclosure relates to a rigid connecting portion or connector for mechanical coupling of components or mechanically coupling a first component and a second component.

The rigid connecting portions for mechanically coupling a first component and a second component are generally used to transmit compression or tension in a mechanical force chain. The rigid connecting portion has at least one opening, in which a bearing, particularly a rubber bearing, also referred to as a rubber bushing, may be arranged when using the connecting portion. This opening is therefore also referred to as a bearing eye.

### BACKGROUND

Typical examples of such rigid connecting portions include control arms or coupling rods. These are used, for example, to mechanically connect a first and a second component that move relative to each other and to transmit any acting forces between them.

It is particularly important in this context that the rigid connecting portion is configured in such a way that it effectively fulfills its intended function in a safe manner, i.e., it is configured so that it does not develop damage during operation, especially not break or develop cracks.

In particular, such rigid connecting portions may be used in vehicle construction as control arms, especially transverse control arms and suspension control arms, or as coupling rods. Such rigid connecting portions are used, for example, for guiding and controlling the wheels of a vehicle or, for instance, for the mechanical coupling of the chassis and an associated stabilizer. DE 10 2012 009 458 A1 describes a novel bearing that elastically connects two components, with at least one of these components being exposed to vibrations. The innovation lies in the use of special bushings equipped with an elastic material to dampen vibrations while ensuring a stable connection between the components. The plug-in system enables easy assembly and adjustment of the damping properties, which is advantageous in many technical applications. Furthermore, the document discloses that the outer sleeve of the bearing bushings essentially has a cylindrical ring shape, with the section facing away from the connecting arm being reinforced. A similar disclosure is found in JP 2021 020 627 A, which focuses on providing a new strength element made of synthetic resin.

### SUMMARY

The aim of the disclosure is to provide a rigid connecting portion for mechanically coupling a first and a second component which has improved properties while maintaining reliability.

The objective is achieved by the subject matter of the disclosure, especially the independent claims. Advantageous further developments of the disclosure are specified in the dependent claims, the description, and the accompanying figures. In particular, the independent claims of one claim category can also be further developed analogously to the dependent claims of another claim category. Further embodiments and developments result from the dependent claims as well as from the description with reference to the figures.

The present disclosure comprises a rigid connecting portion for mechanically coupling a first component and a second component. The connecting portion has at least one opening for accommodating a bearing by which the mechanical coupling can be achieved during operation. The connecting portion has a longitudinal center axis, on which a center point assigned to the opening is arranged. The opening is located in an end region of the connecting portion. The opening is entirely bounded in the radial direction by an inner boundary surface of the connecting portion. Furthermore, the connecting portion has an outer boundary surface that at least partially surrounds the opening, wherein the inner boundary surface and the outer boundary surface are arranged at a distance from each other, so that the connecting portion partially surrounds the opening in a ring-like manner with a ring thickness. The ring thickness is configured to vary in an angular range from 0° to 90° relative to the longitudinal center axis, oriented toward an outer end of the end region, i.e., it is not constant.

The connecting portion is configured as a rigid structure, i.e., it exhibits the properties of a rigid body and is appropriately configured in terms of its strength and stability for its intended use. The rigid configuration ensures direct mechanical coupling, particularly the effective transmission of tensile and compressive forces between a first component and a second component, with which the rigid connecting portion interacts in operation via at least one bearing, rubber bearing, rubber bushing, spherical sleeve joint, or uniball joint arranged in the opening.

The first component and, additionally or alternatively, the second component may be configured as a rigid connecting portion. In particular, the first component and the second component may be components of a vehicle, especially a motor vehicle, particularly a car.

The opening is arranged in at least one end region of the connecting portion, and the center point of the opening is positioned on a longitudinal center axis of the connecting portion. The opening is typically configured symmetrically but may have any desired shape. However, it should advantageously be adapted to the bearing to be used. Preferably, the opening may be circular.

The connecting portion has a longitudinal extension direction. Accordingly, a longitudinal axis of the connecting portion extends. The longitudinal center axis is a longitudinal axis that also passes through a center point of the opening of the connecting portion in its longitudinal extension direction.

The end region refers to a section that comprises an end of the connecting portion along the longitudinal center axis. Generally, multiple end regions, particularly two, are present since the connecting portion has a limited physical extension. Typically, an end region comprises an end of the connecting portion.

The connecting portion may have any desired shape. It comprises at least one end region with an opening. However, at least one additional end region with another opening may also be provided, i.e., at least a second end region with a second opening, and optionally also a third end region with a third opening or more, for example, in the case of a star-shaped configuration of the connecting portion.

If multiple end regions are present, the openings assigned to the end regions may be configured differently. In particular, they may have openings of different sizes with the same or varying cross-sections, and their inner and, additionally or alternatively, outer boundary surfaces may have different configurations in their course.

An intermediate region of the connecting portion, arranged between at least two end regions, may be configured, for example, in a rod-shaped, curved, or irregular form.

The openings may also be arranged in a laterally offset manner. In a non-limiting example, the openings may be arranged point-symmetrically to a center point of the connecting portion so that there are laterally offset openings with a ring structure relative to the longitudinal center axis in two end regions. In particular, a first bearing eye (first opening) may be positioned above the longitudinal center axis, and a second bearing eye (second opening) may be positioned below the longitudinal center axis. The complete radial bounding of the opening by the inner boundary surface of the connecting portion ensures precise positioning of a bearing inserted into the opening, through which the mechanical coupling to the first component and additionally or alternatively to the second component is achieved. The bearing inserted into the opening may be a rubber bearing, rubber bushing, spherical plain bearing, or hydraulic bearing.

The outer boundary surface serves to delineate the rigid connecting portion from its surroundings. The outer boundary surface at least partially surrounds the opening. Since the outer boundary surface is radially farther from the center point of the opening than the inner boundary surface, a ring-like structure is at least partially formed by the connecting portion around the opening. This ring-like structure is referred to as the ring structure in the context of this application. The ring structure may completely encompass the opening, wherein the connecting structure may be integrally connected to the ring structure.

This ring-like structure, which at least partially surrounds the opening, has a ring thickness. According to the disclosure, the ring thickness is configured to vary at least within an angular range of 0° to 90° relative to the longitudinal center axis, oriented toward an outer end of the end region, i.e., it is not constant. In this case, the 90° may be oriented both to the right and to the left, or in other words, to both sides of the longitudinal center axis, meaning in a clockwise as well as a counterclockwise direction. Consequently, the angular values are to be understood as absolute values with respect to the longitudinal center axis.

This allows, on the one hand, for a sufficient ring thickness to be provided in sections of the end region that are subject to high mechanical loads. At the same time, however, it allows for a reduction in ring thickness in sections of the ring structure that are subject to lower mechanical loads.

The herein-disclosed connecting portion may be made without additional manufacturing effort. Several grams per portion can be saved, depending on the portion size and the maximum mechanical load, which enables savings of several tons of material over an annual volume. This provides an advantage both monetarily and in terms of CO₂ emissions.

Thus, compared to the prior art, lighter connecting portions can be provided while still maintaining the desired functionality, particularly in terms of performance and reliability.

The mechanical load on such a connecting portion was analyzed using Finite Element Method (FEM) simulations. It was shown that, for example, with tensile stresses of 40 kN, a variation in ring thickness in the end region is possible while maintaining reliability, allowing the corresponding advantages described.

In one or more embodiments, the ring thickness in an angular range oriented toward the outer end of the end region, starting from the longitudinal center axis, i.e., in a first angular range relative to the longitudinal center axis from 0° to at least 5°, particularly from 0° to at least 10°, and more specifically from 0° to at least 15°, is greater than the ring thickness in a second angular range in the angular range oriented toward the outer end, around 45° (i.e., the angle bisector), particularly in a range of at least 5° on both sides of 45°, more specifically in a range of at least 10° on both sides of 45°, and even more specifically in a range of at least 15° on both sides of 45° relative to the longitudinal center axis. Thus, the second angular range may be aligned starting from the longitudinal center axis around the angle bisector of the angular range oriented toward the outer end of the end region, particularly in a range of at least 5° on both sides of the angle bisector, more specifically in a range of at least 10° on both sides of the angle bisector, and even more specifically in a range of at least 15° on both sides of the angle bisector relative to the longitudinal center axis. It has been shown that, in terms of mechanical loading, it is advantageous to provide such an increase in ring thickness at the end of the connecting portion in the region of the longitudinal center axis, or in other words, to provide a tapering of the ring thickness of the connecting portion in a range around 45° relative to the longitudinal center axis.

In at least one embodiment, the ring thickness in a first angular range oriented toward the outer end of the end region from 0° to at least 10° relative to the longitudinal center axis is greater than the ring thickness in a second angular range of the angular range oriented toward the outer end from at least 40° to 50°, particularly from at least 30° to 60° relative to the longitudinal center axis. It has been shown that, in terms of mechanical loading, it is advantageous to provide such an increase in ring thickness at the end of the connecting portion in the region of the longitudinal center axis.

The ring thickness in an angular range oriented toward the outer end is greater in a third angular range from at least 80° to 90° relative to the longitudinal center axis than the ring thickness in the second angular range from at least 30° to 60° relative to the longitudinal center axis. The third angular range can extend from a straight-line transverse to the longitudinal center axis (90°) toward the associated end region in the angular range oriented toward the outer end by at least 5°, particularly at least 10°, and more specifically at least 15°. It has been shown that, in terms of mechanical loading, it is advantageous to provide such a ring thickness distribution transverse to the longitudinal center axis at the level of the center point of the opening.

The sum of the first angular range, second angular range, and third angular range is less than or equal to 90°. The first, second, and third angular ranges may be arranged in the angular range oriented toward the outer end in a non-overlapping manner. A transition region may be formed in each case between the angular regions.

In a further embodiment, the inner boundary surface may be circular, according to a first circle with a first radius in a longitudinal plane, defined by the longitudinal center axis and the radial direction of the opening. The outer boundary surface in the longitudinal plane may be circular in sections, according to a second circle with a second radius. The first and second circles may be arranged concentrically with respect to one another around the center point of the opening. The second radius may be greater than the first radius. The outer boundary surface may follow the course of the second circle in the first and third angular ranges and deviates from the course of the second circle in the second angular range, in particular where the ring thickness in the second angular range is reduced.

This makes it possible to provide a ring structure, particularly in a symmetrical configuration, which realizes the advantages of the current disclosure while still ensuring a high level of reliability of the connecting portion. In particular, the ring thickness may be selected to be smaller in sections with lower loads.

The inner boundary surface delimiting the opening can have a circular shape as a cross-section in the longitudinal plane. Accordingly, a first circle with a first radius is assigned to the limiting inner boundary surface. The center point of the first circle corresponds to the center point of the opening.

While the cross-section of the inner boundary surface in the longitudinal plane follows the circumferential course of the first circle in its entirety, this does not apply to the outer boundary surface. The outer boundary surface follows the circumference of a second circle arranged concentrically to the first circle of the inner boundary surface only in sections, namely in the aforementioned first and third angular ranges.

In the remaining angular range, where the outer boundary surface does not follow the circular shape with the second radius, the ring thickness of the ring structure is reduced. In other words, the outer boundary surface extends in this remaining angular range, i.e., for example, from 10° to 80° relative to the longitudinal center axis, but does not extend to the second radius. Thus, the ring thickness is smaller in the second angular range than in the aforementioned first and third angular ranges. If the outer boundary surface follows the circumference of a second circle arranged concentrically to the first circle of the inner boundary surface in the first angular range and additionally or in the third angular range, then accordingly, the remaining angular range, where the outer boundary surface does not follow the circular shape with the second radius, is smaller than the region between the first and third angular ranges.

In particular, the outer boundary surface may be formed in a continuously curved manner in the second angular range, for example, from at least 30° to a maximum of 60°, or from at least 10° to a maximum of 80°.

In further embodiments, the outer boundary surface is essentially formed as a plane in the second angular range. In the cross-section of the above-defined longitudinal plane, the course of the boundary surface in the aforementioned angular range appears as a straight-line segment (chord). Such a configuration represents a structurally particularly simple embodiment for achieving the reduction of the ring thickness in the aforementioned angular range to accomplish the weight reduction of the connecting portion.

In at least one embodiment, the plane is arranged tangentially to a third circle, which is concentric with the circles assigned to the inner boundary surface and the outer boundary surface, and which has a third radius that is greater than the first radius and smaller than the second radius. Thus, the third concentric circle in the longitudinal plane has a radius that lies between the first radius and the second radius. By structuring the plane as a tangential plane to the third circle, the ring thickness may be dimensioned in a simple manner to achieve material and weight savings while maintaining reliability.

In a further embodiment, a tangential contact point of the plane may be arranged on a straight line that extends from the center point of the opening at an angle of 45° relative to the longitudinal center axis, oriented toward the outer end. This results in a symmetrical course of the ring thickness in the angular range oriented toward the outer end from 0° to 90° relative to the longitudinal center axis, particularly symmetrically to an angle bisector at 45° relative to the longitudinal center axis.

In a further advantageous embodiment, the first end region may be structured symmetrically to the longitudinal center axis in the longitudinal plane. This results in a longitudinal axis-symmetrical arrangement of the ring thickness for the angular range oriented toward the end from −90° to 90° relative to the longitudinal center axis in the longitudinal plane. According to this embodiment, the advantage of the varying ring thickness over the widest possible angular range is utilized for an end region.

In a further embodiment, a second end region is provided opposite the first end region in the direction of the longitudinal center axis. The second end region may be configured symmetrically to the first end region. An associated transverse symmetry axis may be arranged running through a center point of the connecting portion, perpendicular to the longitudinal center axis in the longitudinal plane. Thus, the connecting portion includes two end regions that are essentially identical in design and realize the advantages of the disclosure.

This results in a dumbbell-like shape of the connecting portion in the longitudinal plane with two bearing eyes.

In particular, the first end region may be connectable to the first component for the purpose of mechanical coupling, and the second end region may be connectable to the second component for the purpose of mechanical coupling.

In an advantageous embodiment, the connecting portion may be configured as a control arm, in particular as a 2-point control arm for a chassis of a vehicle. The control arm may also be referred to as a rod control arm or as a coupling rod for a vehicle. In particular, advantageous embodiments include connecting portions that, during operation, may be exclusively subjected to tensile loading and, additionally or alternatively, to compressive loading.

A connecting portion may be manufactured by casting, forging, or stamping (and bending) from sheet metal. For example, the connecting portion may be forged from an aluminum alloy. However, a corresponding connecting portion, or the bearing eye, may also be produced using other suitable manufacturing methods.

In particular, the connecting portion may be made from plastic or metal. If plastic is used, a further weight reduction may usually be achieved. The use of metallic materials generally allows for a higher mechanical load on the portion.

### BRIEF DESCRIPTION OF THE DRAWINGS

The following describes advantageous exemplary embodiments of the disclosure with reference to the accompanying figures. It shows:

FIG. 1 is a sectional view of a first section of a rigid connecting portion comprising a first end region,

FIG. 2 is a sectional view of a first section of a rigid connecting portion comprising a second end region,

FIG. 3 is a sectional view of a longitudinally symmetrical rigid connecting portion,

FIG. 4 is a sectional view of a rigid connecting portion that is neither longitudinally nor transversely symmetrical, and

FIG. 5 is a top view of a rigid connecting portion that is longitudinally and transversely symmetrical.

### DETAILED DESCRIPTION

The figures are merely schematic representations and serve only to illustrate the exemplary embodiments of the disclosure. Identical or functionally equivalent elements are consistently provided with the same reference numerals. The respective reference numerals are generally introduced only in the figure in which they are first used and are assumed to be known in subsequent figures.

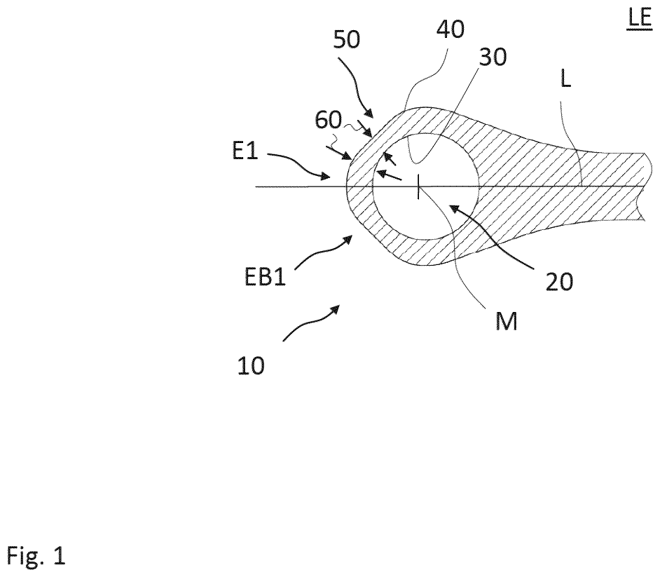

FIG. 1 shows a sectional view of a portion of a rigid connecting portion 10, in particular a coupling rod 10, for the mechanical coupling of a first component and a second component of a vehicle, which includes a first end region EB1. The first component and the second component are not shown in the figures.

The view according to FIG. 1 includes a so-called bearing eye in the first end region EB1. For this purpose, the coupling rod 10 has an opening 20 in the end region EB1. This opening 20 is intended to accommodate a bearing during operation, through which the mechanical forces act on the coupling rod 10. The bearing is not shown in the figures. The first end region EB1 further includes an outer first end E1 of the coupling rod 10.

The opening 20 has a center point M and a circular cross-section in a longitudinal plane LE, which corresponds to the section plane and at the same time to the plane of the sheet.

The center point M of the opening 20 is furthermore arranged on a longitudinal center axis L of the coupling rod 10 which extends in the longitudinal plane LE. The outer first end E1 of the coupling rod 10 is also arranged on the longitudinal center axis L. The first end region EB1 is configured to be axially symmetrical relative to the longitudinal center axis L in the longitudinal plane LE.

The opening 20 for accommodating the bearing is defined in the radial direction by an inner boundary surface 30 of the coupling rod 10. The inner boundary surface 30 defines the opening 20 in the radial direction, i.e., the inner boundary surface extends around the center point M of the opening 20 by 360°.

The inner boundary surface 30 has a circular cross-section in the longitudinal plane LE. In this case, the inner boundary surface 30 spatially forms a cylindrical lateral surface, in particular with a constant diameter. However, the inner boundary surface 30 may also have a different configuration. In a non-limiting example, a bearing in the opening 20 may be fixed by the shape of the opening 20 or the shape of the inner boundary surface 30.

At least in sections, an outer boundary surface 40 surrounds the opening 20. The outer boundary surface 40 and the inner boundary surface 30 simultaneously form the boundary for a ring structure 50, which is located in front of the coupling rod 10 and is configured to be solid, in particular, and which extends at least in sections around the opening 20.

In FIG. 1, two exemplary ring thicknesses 60 are marked which show that the ring thickness 60 is configured to be variable along the circumferential direction of the opening 20, i.e., it is not constant.

By deviating from a constant ring thickness 60—in light of the intended load for the coupling rod—the ring structure 50 allows material savings for the bearing eye, enabling the bearing eye and the coupling rod 10 to be configured in an especially lightweight and material-efficient manner.

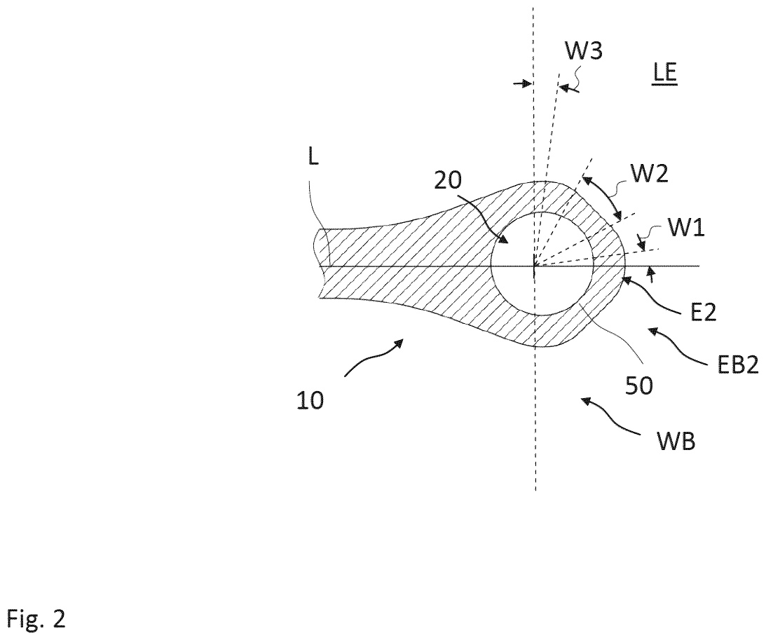

FIG. 2 shows a sectional view of a portion of a rigid connecting portion 10 in the longitudinal plane LE, in particular a coupling rod 10, for the mechanical coupling of a first component and a second component of a vehicle, which includes a second end region EB2.

This second end region EB2 also includes a bearing eye, i.e., an opening 20 for accommodating a bearing during operation, through which the mechanical forces act on the coupling rod 10. The opening 20 is at least partially surrounded by a ring structure 50 with a variable ring thickness.

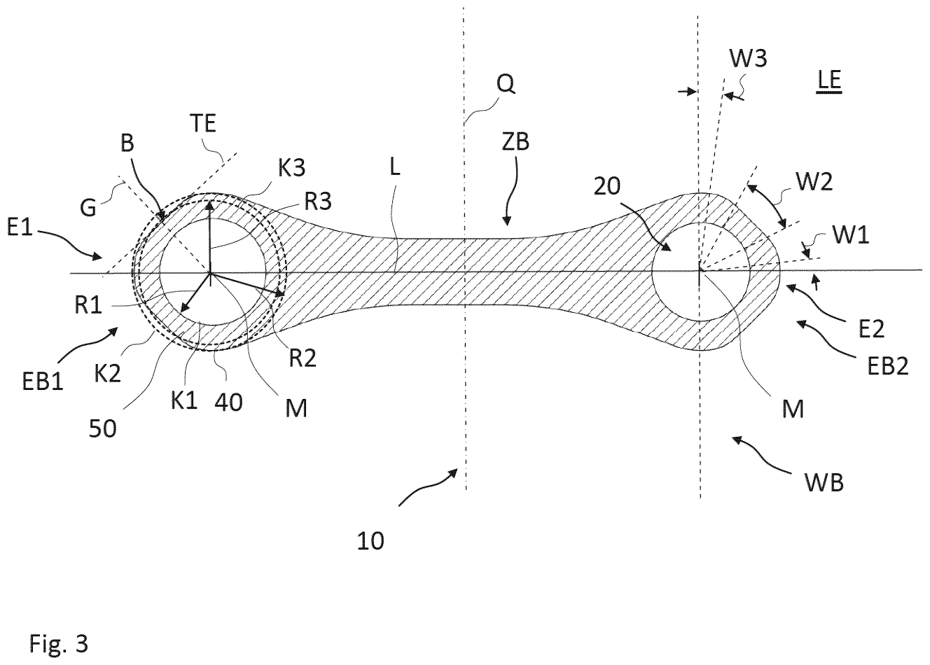

The second end region EB2 includes an outer second end E2 of the coupling rod 10. The angular ranges that are significant, according to a non-limiting example, are explained with reference to FIG. 2. The explanations may be applied analogously to the representation in FIG. 1 and FIG. 3. In particular, an angular measurement is also performed for the end region EB1, shown in FIG. 1, in the angular range oriented toward the outer end E1.

FIG. 2 includes an angular range WB oriented toward the outer second end E2. This angular range oriented toward the outer end is from −90° to 90° relative to the longitudinal center axis L. In the same manner, an angular range oriented toward the outer first end E1 of the coupling rod 10 is present according to FIG. 1.

The angles in the angular range WB oriented toward the outer second end E2 may be specified in the present context relative to the longitudinal center axis L. The angle specification may be chosen such that it denotes the smallest angular distance from the longitudinal center axis, i.e., according to FIG. 2, the angle measurement being performed to the ‘right’ from the longitudinal center axis L, while in FIG. 1, it is performed to the ‘left’ from the longitudinal center axis L. Angles measured counterclockwise from the longitudinal center axis L in the second end region EB2 are considered positive angles. Conversely, angles measured clockwise from the longitudinal center axis L in the second end region EB2 are considered negative angles. The same applies inversely to the first end region EB1. In summary, angles measured ‘downward’ relative to the longitudinal center axis L are negative, and angles measured ‘upward’ relative to the longitudinal center axis L are positive. The angles or angular ranges stated in the claims are to be understood as absolute values, i.e., only in relation to the longitudinal center axis L, without a positive or negative direction assigned to them. The material savings can be realized at one, two, three, or four angle bisectors relative to the longitudinal center axis L.

As can be seen from FIG. 2, a first angular range W1, a second angular range W2, and a third angular range W3 are provided. The first angular range W1 is from 0° to 10°, relative to the longitudinal center axis L, the second angular range W2 is from 30° to 60°, relative to the longitudinal center axis L, and the third angular range W3 is from 80° to 90°, relative to the longitudinal center axis L. The same applies accordingly to the same angular ranges with a negative sign as shown in FIG. 1 and FIG. 2.

As can be seen from FIG. 2, in the angular range W1, the ring thickness of the ring structure of the bearing eye may be greater than in the angular range W2. Furthermore, as can be seen from FIG. 2, in the angular range W3, the ring thickness may be greater than in the angular range W2. In particular, the ring thickness in the angular ranges W1 and W3 may be equal, whereas the ring thickness may be smaller in the angular range W2 than the ring thickness in the angular ranges W1 and W3.

These statements apply correspondingly to the angular ranges W1, W2, and W3 with a negative sign. In particular, the second end region EB2 may be formed to be axially symmetric to the longitudinal center axis L in the longitudinal plane LE.

FIG. 3 shows a sectional view of a coupling rod 10 in the longitudinal plane LE, which has first end regions EB1 and second end regions EB2, formed axially symmetrically in the longitudinal plane LE relative to the longitudinal center axis L. The bearing eye in the second end region EB2 may have a smaller diameter than the bearing eye in the first end region EB1. A rod-shaped, in particular rectilinear, intermediate region ZB may be arranged between the first end region EB1 and the second end region EB2.

The second end region EB2 of the exemplary embodiment shown in FIG. 3 corresponds to the second end region EB2 of FIG. 2. The first end region EB1 corresponds to the first end region EB1 of FIG. 1, but includes further explanations regarding the nature of the ring structure 50.

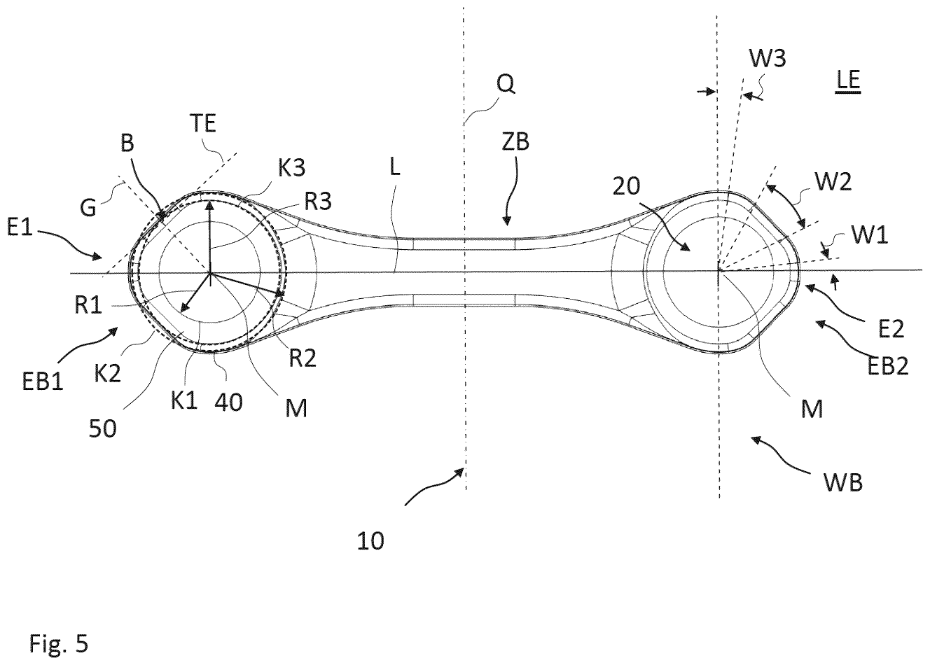

In another exemplary embodiment shown in FIG. 5, the rigid connecting portion has axially symmetrical first end regions EB1 and second end regions EB2, wherein the axial symmetry is present in the longitudinal plane LE both relative to the longitudinal center axis L and to a transverse center axis Q extending through a center point of the coupling rod and arranged in the longitudinal plane LE. In such an embodiment, the first opening 20 in the first end region EB1 and the second opening 20 in the second end region EB2 may be identical, i.e., the first radius R1 of the first opening 20 corresponds to the first radius R1 of the second opening 20. FIG. 5 shows a top view in contrast to the other figures, which depict sectional views.

From FIG. 3, it can be seen that the cross-section of the opening 20 in the longitudinal plane LE has a circular shape. This circular shape is associated with a first circle K1 with a first radius R1, the center of which coincides with the center M of the opening 20.

Furthermore, in FIG. 3, a second circle K2 with a radius R2 is shown, the center of which also coincides with the center M of the opening 20. The course of the circumference of the second circle K2 describes, at least in sections, in particular in the angular range W1 and the angular range W3, as well as in their reflection on the longitudinal center axis, the course of the outer boundary surface 40 of the coupling rod 10. The angular ranges W1, W2, and W3 are not shown in the first end region EB1 for the sake of clarity but remain visible from the second end region EB2 and can be correspondingly transferred to the first end region EB1.

Furthermore, FIG. 3 includes a third circle K3 with a third radius R3, the center of which coincides with the center M of the opening 20. The third radius R3 is greater than the first radius R1. Furthermore, the third radius R3 is smaller than the second radius R2.

The ring structure 50 is configured such that in angular ranges W1 and W3, the second circle, in particular its circumference, defines the course of the outer boundary surface 40, whereas in angular range W2, the outer boundary surface 40 is essentially formed as a plane.

The course of the outer boundary surface 40 of the ring structure 50 in angular range W2 can be determined such that a straight-line G is provided, starting from the center point M at a 45° angle, oriented toward the outer first end E1, relative to the longitudinal center axis L, which intersects the second circle K2 at a point B. The point B is the tangential contact point B of the partially planar outer boundary surface 40 with the second circle K2. Thus, in angular range W2, the outer boundary surface 40 forms a tangential plane TE to the circumference of the second circle K2.

Significant material savings for the less loaded sections of the ring structure 50 of the herein-disclosed coupling rod 10 may be achieved while maintaining the reliability of the bearing eye or the coupling rod 10. This is especially so when the first end region EB1 is configured to be axially symmetric relative to the longitudinal center axis L in the longitudinal plane LE and, furthermore, the second end region EB2 is configured to be axially symmetric relative to the transverse center axis Q in the longitudinal plane LE.

The bearing eyes configured in this manner are especially advantageous under tensile strength. The stress peaks occur at 0°, 90°, and −90° from the longitudinal center axis. In between, particularly at 45°, there are regions with comparatively lower stress absorption which enables thickness reduction of the ring structure of the bearing eye in these regions.

Such a coupling rod 10 according to FIG. 1 to FIG. 3 may be made from plastic or metal, depending on the intended load.

Since the devices described in detail above are exemplary embodiments, they can be modified to a great extent in a conventional manner by a person skilled in the art without departing from the scope of the disclosure. In particular, the mechanical arrangements and the size ratios of the individual elements to one another are merely exemplary.

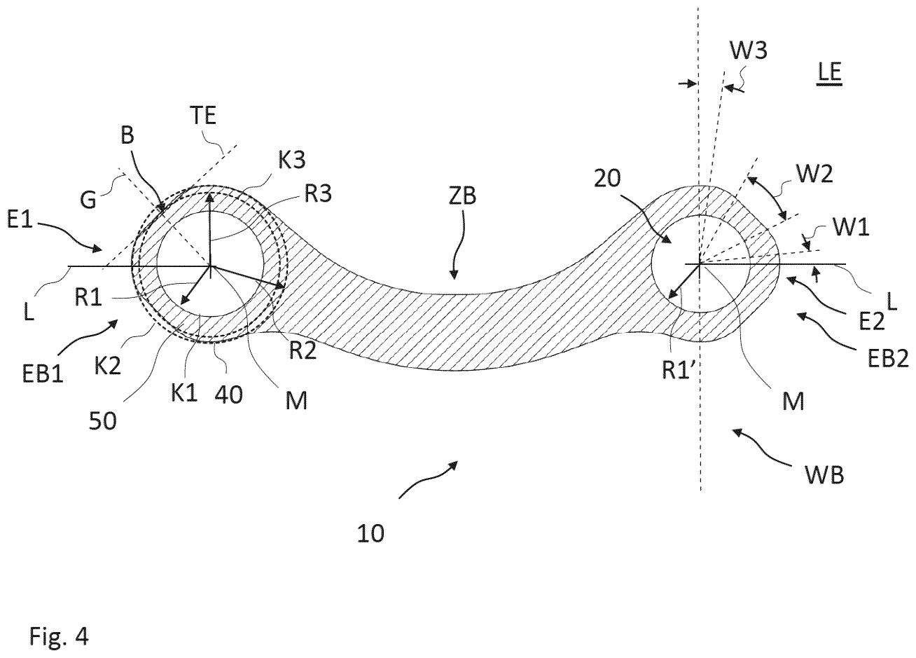

FIG. 4 shows a sectional view of a coupling rod 10 in the longitudinal plane LE, which has a first end region EB1 and a second end region EB2. FIG. 4 includes the reference signs of FIG. 3 and adds additional reference signs that indicate the differences.

The bearing eyes arranged in the end regions EB1 and EB2, respectively, have openings 20 with different radii in contrast to FIG. 5, namely with radius R1 for the bearing eye oriented to the left in FIG. 4 and with radius R1′ for the bearing eye oriented to the right in FIG. 4. This results in an asymmetrical configuration of the first and second end regions EB1 and EB2.

According to FIG. 4, the radius R1′ is smaller than the radius R1. Since the radii R2 and R3 of the second circle K2 and the third circle K3 are dimensioned the same for the right-side bearing eye as for the left-side bearing eye, the right-side bearing eye overall has a greater ring thickness for the ring structure at least partially surrounding the opening. The outer boundary surface 40 follows the second circle in both end regions EB1 and EB2 in sections in the angular ranges W1 and W3, while the outer boundary surface 40 in the angular range W2 is formed as a tangential plane TE to the third circle.

Furthermore, FIG. 4 shows an intermediate region ZB arranged between the first and the second end region EB1 and EB2, which has a curvature, i.e., it is not formed in a straight line. In this case, the longitudinal center axis L follows the centerline of the connecting piece or the coupling rod 10. In the first and second end regions EB1 and EB2, the longitudinal center axis L runs horizontally in the longitudinal plane LE.

The curvature of the intermediate region ZB can, for example, be configured to be axially symmetric with respect to a transverse center axis not shown in FIG. 4, or point-symmetric to a center point of the coupling rod 10, or symmetrically in another manner. It is also possible that no symmetry is provided for the intermediate region ZB.

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### REFERENCE DESIGNATION LIST

10 Rigid connecting portion
20 Opening
30 Inner boundary surface
40 Outer boundary surface
50 Ring structure
60 Ring thickness
L Longitudinal center axis
LE Longitudinal plane
M Center point of the opening
EB1 First end region
EB2 Second end region
E Outer end
K1 First circle
K2 Second circle
K3 Third circle
R1 First radius
R2 Second radius
R3 Third radius
WB Angular range oriented toward the outer end
W1 First angular range, for example, 0° to 10°
W2 Second angular range, for example, 30° to 60°
W3 Third angular range, for example, 80° to 90°
B Tangential contact point
TE Tangential plane
G Line
Q Transverse center axis
ZB Intermediate region

What is claimed is:

1. A rigid connecting portion for mechanical coupling of at least a first component and a second component, the rigid connecting portion comprising:
at least one opening;
a longitudinal center axis with a center point assigned to the opening;
at least one end region in which the opening is arranged;
an outer boundary surface at least partially surrounding the opening; and
an inner boundary surface configured such that the opening is entirely bounded in a radial direction by the inner boundary surface,
the inner boundary surface and the outer boundary surface being arranged at a distance from each other such that the rigid connecting portion partially surrounds the opening in a ring-like manner with a ring thickness varying in an angular range oriented toward an outer end of the at least one end region from 0° to 90° relative to the longitudinal center axis,
the ring thickness in an angular range oriented toward the outer end from at least 80° to 90° relative to the longitudinal center axis being greater than the ring thickness in an angular range oriented toward the outer end from at least 30° to 60° relative to the longitudinal center axis.

2. The rigid connecting portion according to claim 1, wherein the at least one opening is configured to accommodate a bearing.

3. The rigid connecting portion according to claim 1, wherein the ring thickness in an angular range oriented toward the outer end of the at least one end region from at least 0 to 10° relative to the longitudinal center axis is greater than the ring thickness in the angular range oriented toward the outer end from at least 30° to 60° relative to the longitudinal center axis.

4. The rigid connecting portion according to claim 1, wherein the ring thickness in an angular range oriented toward the outer end of the at least one end region, starting from the longitudinal center axis, in a first angular range of at least 5°, is greater than the ring thickness in the angular range oriented toward the outer end of the at least one end region, starting from the longitudinal center axis, in a second angular range around an angle bisector of the angular range oriented toward the outer end of the at least one end region.

5. The rigid connecting portion according to claim 1, wherein the ring thickness in an angular range oriented toward the outer end of the at least one end region, starting from the longitudinal center axis, in a first angular range of at least 10°, is greater than the ring thickness in the angular range oriented toward the outer end of the at least one end region, starting from the longitudinal center axis, in a second angular range around an angle bisector of the angular range oriented toward the outer end of the at least one end region.

6. The rigid connecting portion according to claim 4, wherein the second angular range around an angle bisector of the angular range oriented toward the outer end of the at least one end region includes a region of at least 5° on both sides of the angle bisector relative to the longitudinal center axis.

7. The rigid connecting portion according to claim 5, wherein the second angular range around an angle bisector of the angular range oriented toward the outer end of the at least one end region includes a region of at least 10° on both sides of the angle bisector relative to the longitudinal center axis.

8. The rigid connecting portion according to claim 1, wherein the inner boundary surface in a longitudinal plane, formed by the longitudinal center axis and the radial direction of the opening, is circular in shape according to a first circle with a first radius,
wherein the outer boundary surface in the longitudinal plane is partially circular in shape according to a second circle with a second radius,
wherein the first and the second circles are arranged concentrically relative to each other, and the second radius is greater than the first radius,
wherein the outer boundary surface follows a circumferential course of the second circle in a first angular range relative to the longitudinal center axis and in a third angular range relative to the longitudinal center axis, and
wherein the outer boundary surface deviates from a course of the second circle in a second angular range relative to the longitudinal center axis.

9. The rigid connecting portion according to claim 8, wherein the first and second circles are arranged concentrically relative to each other in in the longitudinal plane, around the center point of the opening.

10. The rigid connecting portion according to claim 9, wherein the ring thickness is reduced.

11. The rigid connecting portion according to claim 8, wherein the outer boundary surface in the second angular range is a plane.

12. The rigid connecting portion according to claim 11, wherein the plane is arranged tangentially to a third circle, which is arranged concentrically to the first circle and the second circle and has a third radius, wherein the third radius is greater than the first radius, and the third radius is smaller than the second radius.

13. The rigid connecting portion according to claim 12, wherein a tangential contact point of the plane on the third circle is arranged on a straight line extending from the center point of the opening at an angle of 45° oriented towards the outer end relative to the longitudinal center axis.

14. The rigid connecting portion according to claim 1, wherein the at least one end region includes a first end region symmetrical to the longitudinal center axis in a longitudinal plane, formed by the longitudinal center axis and a radial direction of the opening.

15. The rigid connecting portion according to claim 14, wherein the at least one end region includes a second end region arranged opposite the first end region in a direction of the longitudinal center axis.

16. The rigid connecting portion according to claim 15, wherein the second end region is symmetrical to the first end region, wherein an associated transverse symmetry axis extends through a center point of the connecting portion perpendicular to the longitudinal center axis in the longitudinal plane.

17. The rigid connecting portion according to claim 15, wherein the at least one end region includes a third end region with a third opening, and the rigid connecting portion is star-shaped.

18. The rigid connecting portion according to claim 1, wherein the rigid connecting portion is a control arm.

19. The rigid connecting portion according to claim 1, wherein the rigid connecting portion is a coupling rod.

20. The rigid connecting portion according to claim 1, wherein the rigid connecting portion is a motor vehicle component.
